(19) United States
(12) Patent Application Publication
(10) Pub. No.: US 2002/0005013 A1
(43) Pub. Date: Jan. 17, 2002

(54) Post planter

(76) Inventor: William L. Taylor, Roscoe, IL (US)

Correspondence Address: LEYDIG VOIT & MAYER, LTD, 6815 WEAVER ROAD, ROCKFORD, IL, 61114-8018, US

(21) Appl. No.: 09/946,224

(22) Filed: Sep. 5, 2001

Related U.S. Application Data
(60) Provisional application No. 60/301,241, filed on Jun. 26, 2001.

(51) Int. Cl. A01G 9/02

(52) U.S. Cl. 47/66.6

(57) ABSTRACT

A post planter has been presented that is removably attached to a support post of a deck or porch. The post planter is attached at any height along the support post and is made of two sections that wrap around the support post and are held together by clips at the top and a mounting mechanism that is attached to the support post. The post planter outer walls have holes to allow plants to grow through and are manufactured in a variety of sizes.

### CROSS-REFERENCE TO RELATED PATENT APPLICATIONS

This patent application claims the benefit of U.S. provisional patent application 60/301,241, filed Jun. 26, 2001.

### FIELD OF THE INVENTION

The present invention relates generally to a plant receptacle, and more particularly relates to a plant receptacle to be used in combination with a post.

### BACKGROUND OF THE INVENTION

Many people throughout the world are proud of their homes and spend a great deal of effort in improving the appearance of their homes. Many of these homes have decks or porches that are used for a wide range of outdoor activities such as dining, socializing, relaxing, etc. There have been a number of things done to improve the appearance of the decks and porches. For example, trellises are often placed nearby to provide some privacy and to allow vines to grow on the trellises. Plants are typically planted around decks or porches and in plant receptacles that are placed on the decks/porches and furniture to improve the appearance and to provide a soothing and aesthetic effect. Plants have even been planted in receptacles that have been developed for umbrella tables to approve the appearance of the umbrella pole going through the center of the table.

While much effort has gone into improving the appearance of the deck/porch surface and furniture, other sections of the deck/porch still appear drab and detract from the overall appearance of the home. One section of the deck/porch that appears drab is the support posts. Many people have attempted to improve the appearance by placing plants in plant receptacles on the ground surrounding the exposed portions of the support posts. However, these plants can easily be knocked over when someone bumps it or disturbs it.

### BRIEF SUMMARY OF THE INVENTION

In light of the above, it is a general aim of the present invention to improve the appearance of support posts.

In that regard, it is an object of the present invention to provide a plant receptacle for a support post that does not cause structural damage to the support post.

It is another object of the present invention to provide a plant receptacle that is not easily knocked over.

It is a further object of the present invention to provide a post planter that is self-contained to prevent soil and moisture from damaging the deck.

A further object of the present invention is to provide a post planter that wraps around a support post.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is an isometric view of a post planter according to a first embodiment of the present invention;

FIG. 2 is a side view of the post planter of FIG. 1;

FIG. 3 is an isometric view of a post planter according to a second embodiment of the present invention;

FIG. 4 is a side view of the post planter of FIG. 3;

FIG. 5 is a top view of a circular shaped post planter in accordance with the present invention;

FIG. 6a is an isometric view along line 6-6 of FIG. 5 illustrating an interlock mechanism used in accordance with the present invention;

FIG. 6b is an isometric view of an alternate embodiment of the interlock mechanism.

FIG. 7 is a top view of a square shaped post planter in accordance with the present invention;

FIG. 8 is a top view of a hexagonal shaped post planter in accordance with the present invention;

FIG. 9 is a top view of an alternate embodiment of a hexagonal shaped post planter in accordance with the present invention;

FIG. 10 is a top view of a circular shaped post planter in accordance with the present invention;

FIG. 11a is a top view of a post planter in accordance with the present invention for screened porches and decks;

FIG. 11b is a top view of an alternate embodiment of a post planter in accordance with the present invention for screened porches and decks;

FIG. 12a is a top view of an alternate embodiment of a circular shaped post planter having a recess for a mounting mechanism in accordance with the present invention;

FIG. 12b is a side view of a circular shaped post planter having a recess for an mounting mechanism in accordance with the present invention taken along line 12b-12b of FIG. 12a;

FIG. 13a is a top view of an alternate embodiment of a circular shaped post planter having a recess for a mounting mechanism in accordance with the present invention;

FIG. 13b is a side view of the mounting mechanism of FIG. 13a taken along line 13b-13b;

FIG. 13c is an isometric view of the mounting mechanism of FIG. 13a;

FIG. 14a is a top view of an embodiment of a circular shaped post planter having a recess for an alternate embodiment of a mounting mechanism according to one embodiment of the present invention;

FIG. 14b is a side view of the mounting mechanism of FIG. 14a taken along line 14b-14b;

FIG. 14c is an isometric view of the mounting mechanism of FIG. 14a;

FIG. 15a is a front view of an alternative mounting mechanism in accordance with the present invention;

FIG. 15b is a cross-sectional view of the mounting mechanism of FIG. 15a and a post planter; and

FIG. 15c is a cross-sectional view of the mounting mechanism and post planter of FIG. 15b along line 15c.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

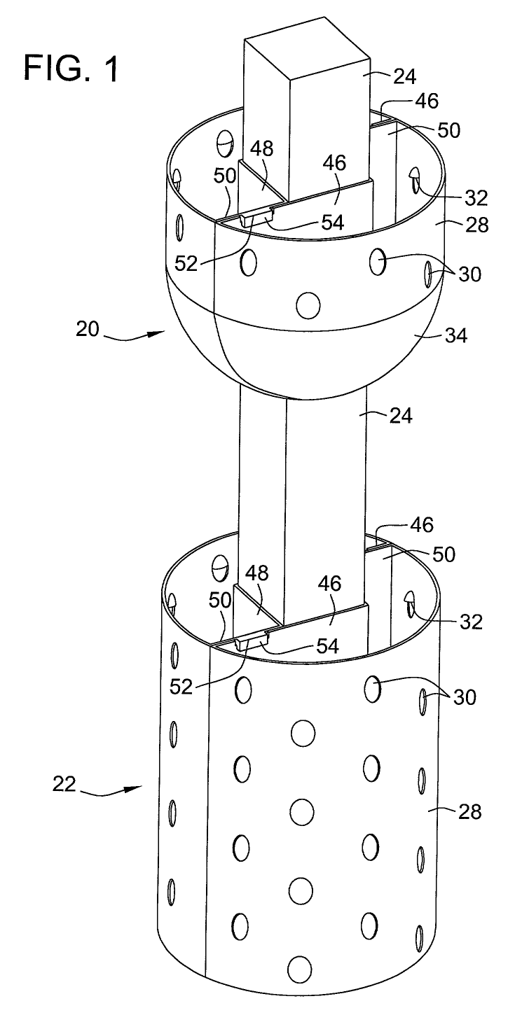

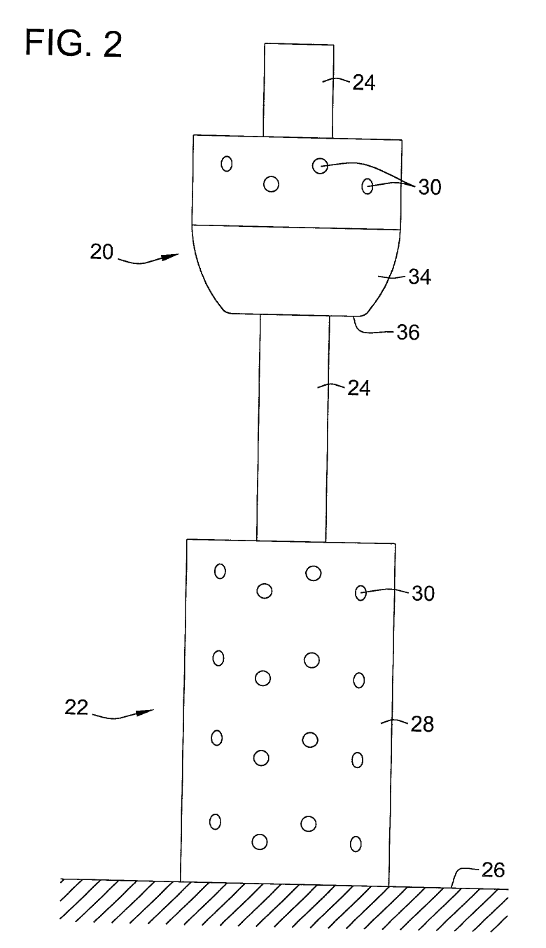

Turning to the drawings, wherein like reference numerals refer to like elements and for purposes of illustration, a first embodiment of the present invention has been illustrated in FIGS. 1 and 2 as post planters 20, 22 removably attached to a support post 24 of a deck or porch (not shown). Post planter 20 is attached at any height along the support post 24. Post planter 22 is attached to the support post 24 so that it rests on a relatively flat surface 26 such as the ground or floor (see FIG. 2).

Holes 30 are placed on the outer surface 28 of the post planter 20, 22 to allow plants to grow from the sides of the post planter 20, 22. Each hole 30 has a lip 32 that prevents soil from spilling out of the post planter 20, 22. The lip is integrally formed with the hole 30 in one embodiment. In an alternate embodiment, the lip is formed by a plastic or ceramic cylinder that is press-fit into the hole 30. While the figures show the post planters having holes, it should be recognized that the post planter 20, 22 may be made with fewer holes, holes along a specific section of the outer surface, or with no holes.

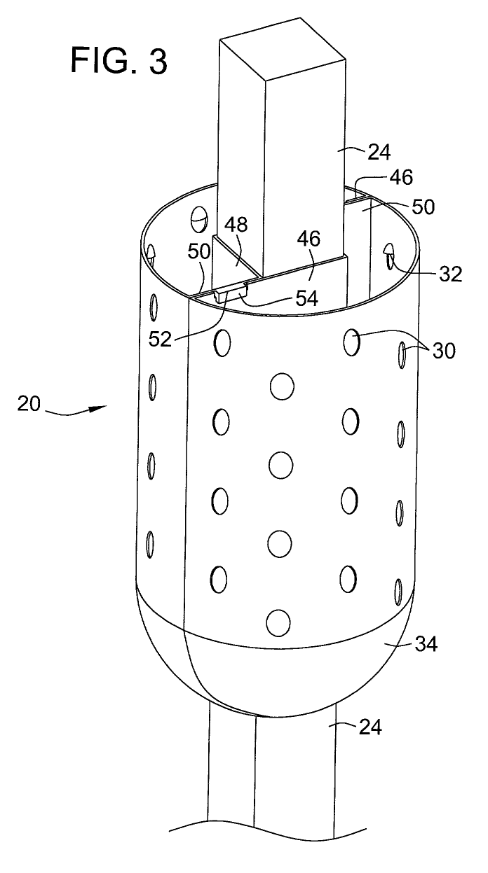

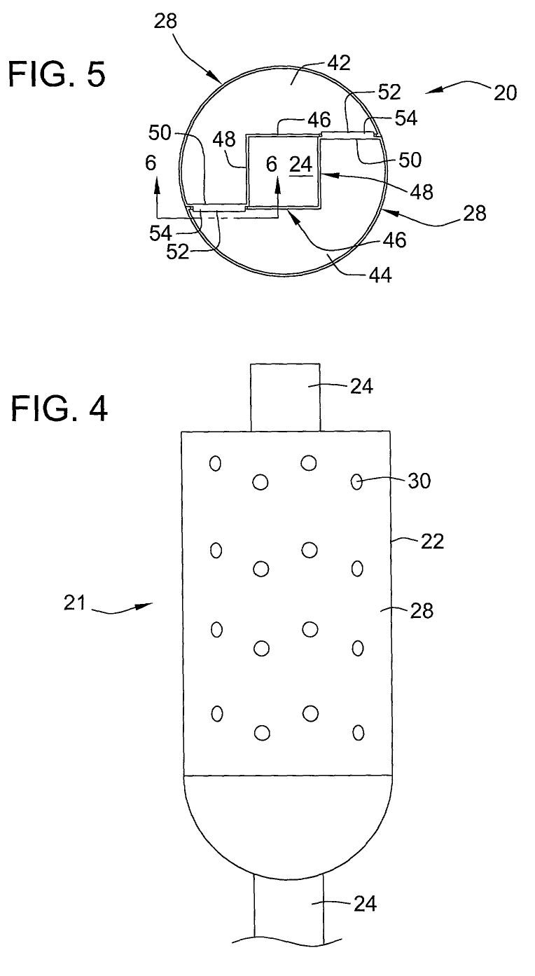

Post planter 20 has a curved bottom surface 34. In one embodiment, the curved bottom surface 34 ends in a bottom 36 that is substantially flat (see FIG. 2). In other embodiments, the bottom surface 34 is completely curved (see FIGS. 3 and 4). The post planters 20, 22 can be made of any length. For example, the post planter 21 illustrated in FIG. 3 is longer than post planter 20. The post planters may have drain holes in the bottom and drain trays attached to the bottom.

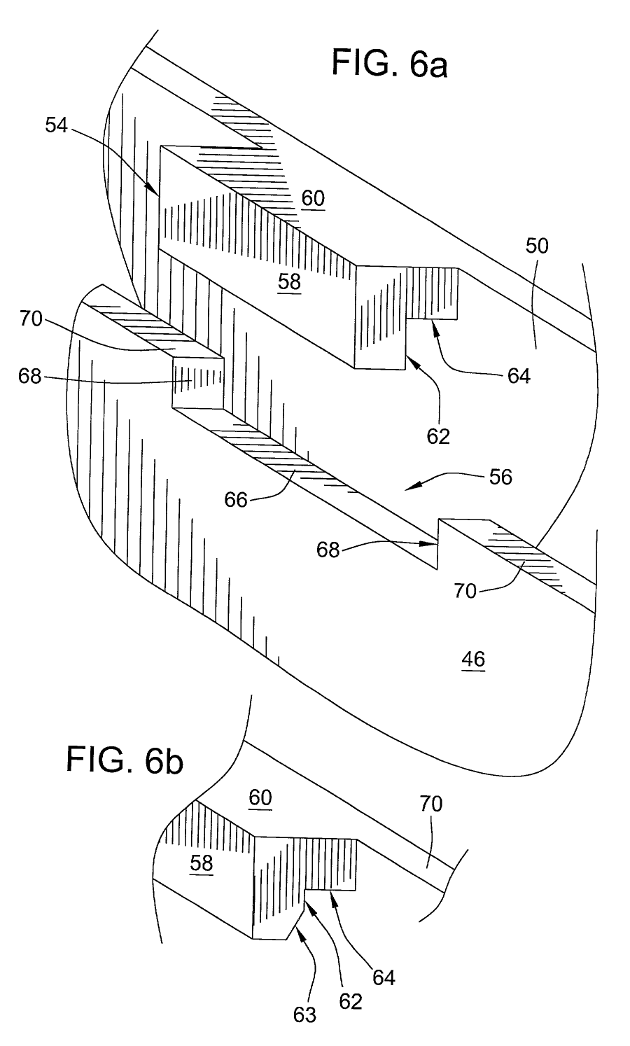

The post planters 20-22 are generally comprised of two pieces and can be made in a variety of shapes and sizes. For example, FIGS. 5 to 11 show alternate embodiments of post planters. FIG. 5 illustrates an embodiment of a circular shaped post planter 40. The post planter 40 comprises two substantially identical sections 42, 44. The walls 46, 48 of the sections 42, 44 are mounted to the support post 24 as described hereinbelow. The length of the wall 48 is sized so that the wall 50 of each of the sections 42, 44 contacts the wall 46 of the other of the sections 42, 44 when the post planter 40 is mounted to the support post 24. The length of wall 46 is set to equal the sum of the lengths of walls 48, 50. The sections 42, 44 are held together at the top by a clip 52. In one embodiment, the clip 52 comprises am interlock mechanism 54 that is integrally formed with the wall 50 that fits over a slot 56 (see FIG. 6) formed in the wall 46.

FIG. 6a illustrates the interlock mechanism 54 and slot 56. The interlock mechanism 54 is integrally formed with the wall 50 and has outer surfaces 58, 60 and inner surfaces 62, 64. The outer surfaces 58, 60 are generally orthogonal to each other. The inner surfaces 62, 64 are approximately orthogonal to each other. The slot 56 has surface 66 and side walls 68. When the sections 42, 44 are attached to the support post 24, the top of wall 50 of each section 42, 44 is held to the top of wall 46 by the interlock mechanism 54. The interlock mechanism 54 fits into the slot 56. When installed, the inner surface 64 sits on surface 66 and inner surface 66 generally contacts wall 46. The outer surface 60 is generally flush with the top 70 of the wall 46. The length of surface 66 is selected so that there is sufficient tolerance for the interlock mechanism to hold the tops of the sections 42, 44 together due to manufacturing tolerances of the support post and post planter. In one embodiment, the inner surface 62 has a sloped or beveled portion at the end 63 that is opposite to the end that contacts inner surface 64 (see FIG. 6b). The sloped or beveled portion makes it easier to slide the interlock mechanism 54 into place.

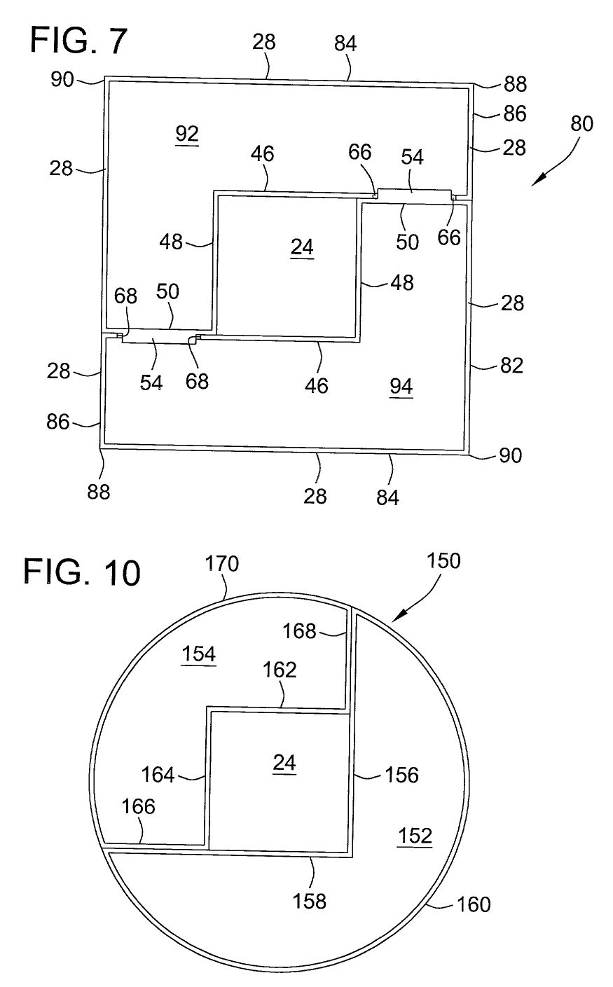

FIG. 7 shows an alternate embodiment of the present invention. In FIG. 7, the outer surface 28 of post planter 80 comprises walls 82, 84, 86 that are approximately orthogonal to each other. The edges 88, 90 where the wall 82 contacts wall 84 and wall 86 may be rounded so that the edges 88, 90 are not sharp. The sections 92, 94 of the post planter 80 are substantially identical to each other.

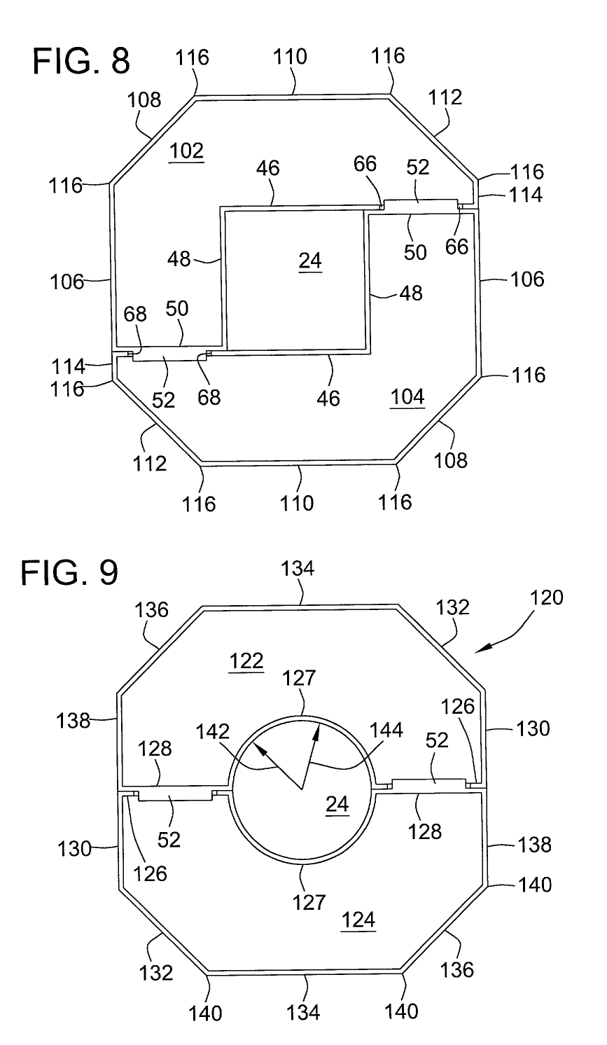

Turning now to FIG. 8, an embodiment of the present invention where the post planter 100 is hexagonal in shape is shown. The post planter comprises sections 102, 104 that are substantially identical to each other. The outer surface 28 comprises walls 106-114. The edges 116 of the walls 106-114 may be rounded to avoid sharp edges.

It should be noted that the support post 24 may be of any shape. For example, in the preceding figures, the support post is shown as a square shaped post. For example, FIG. 9 shows a hexagonal shaped post planter 120 for a circular shaped support post 24. The post planter 120 comprises sections 122, 124 that are substantially identical to each other. Each section 122, 124 has inner walls 126-128 and outer walls 130-138. The edges 140 of the walls 130-138 may be rounded to avoid sharp edges. The inner wall 127 is arched and the inner radius 142 of the inner wall 127 is sized to be slight larger than the radius 144 of the support post 24 such that the post planter 120 fits snugly against the support post 124.

While the sections of the post planter embodiments shown in FIGS. 5 and 7-9 are substantially identical, it should be noted that the sections of the post planter may be different from each other. For example, FIG. 10 shows an embodiment of a post planter 150 that has differently shaped sections 152, 154. Section 152 has inner walls 156, 158 and outer wall 160. Section 154 has inner walls 162-168 and outer wall 170. The inner walls 156, 158 of section 152 have substantially identical lengths. The inner walls 162, 164 of section 154 have substantially equal lengths and the lengths of inner walls 166, 168 are also substantially equal.

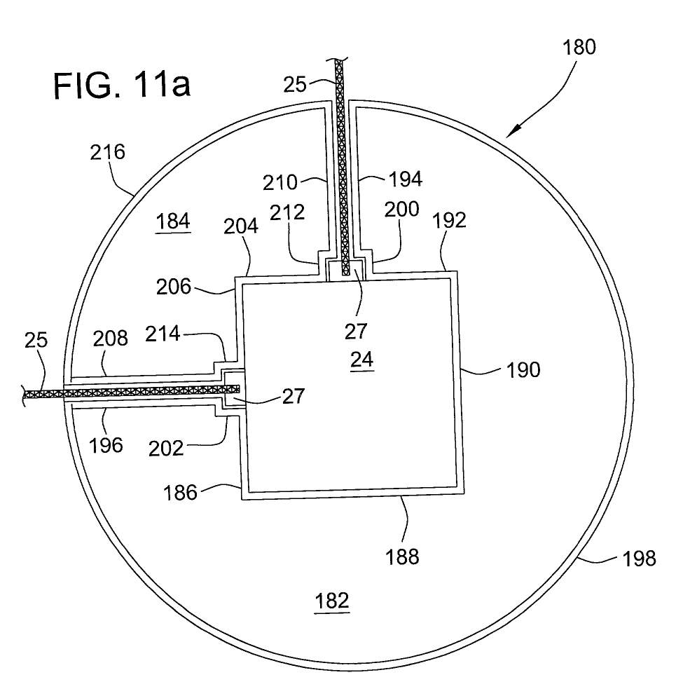

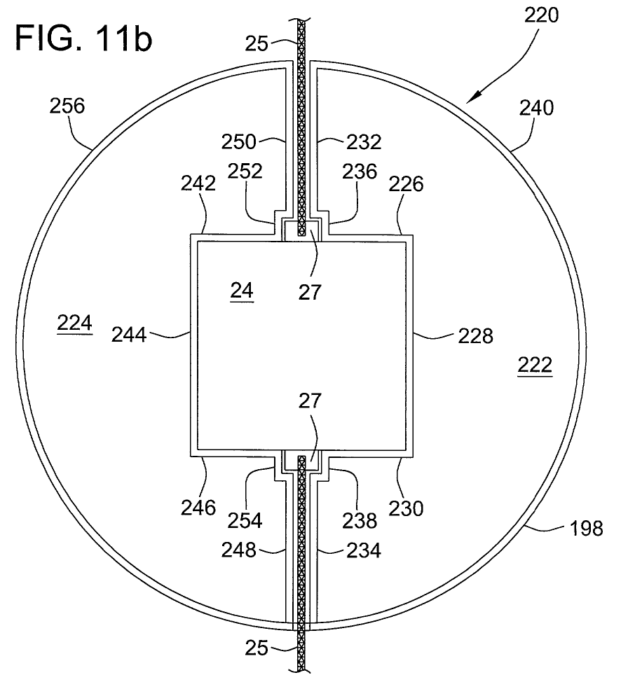

Screens or windows enclose some decks and porches. FIGS. 1a and 11b illustrate embodiments of post planters in accordance with the present invention for support posts having screens or windows. While FIGS. 11a and 11b illustrate the screen being located near the middle of the support post, it should be recognized that the screen may be located at any location along the support post. FIG. 11a illustrates a post planter for a support post 24 located at a corner of the deck/porch. In this embodiment, the post planter 180 is comprised of sections 182, 184. Section 182 fits outside the deck/porch and has inner walls 186-192 that contact the support post 24, side walls 194, 196 that are parallel to screen/glass 25, notches 200, 202 and outer wall 198. The side walls 194, 196 may contact the screen/glass 25 or be separated from the screen/glass 25 by a gap. The notches 200, 202 are sized so that the section 182 does not come into contact with the screen/glass frame 27. Section 184 fits on the support post 24 inside the screen/glass 25 and has inner walls 204-206 that contact the support post 24, side walls 208, 210 that are parallel to screen/glass 25, notches 212, 214 and outer wall 216. The side walls 208, 210 may contact the screen/glass 25 or be separated from the screen/glass 25 by a gap. The notches 212, 214 are sized so that the section 184 does not come into contact with the screen/glass frame 27.

FIG. 11b illustrates a post planter for a support post 24 located between corners of the deck/porch. In this embodiment, the post planter 220 is comprised of sections 222, 224. Section 222 has inner walls 226-230 that contact the support post 24, side walls 232, 234 that are parallel to screen/glass 25, notches 236, 238 and outer wall 240. The side walls 232, 234 may contact the screen/glass 25 or be separated from the screen/glass 25 by a gap. The notches 236, 238 are sized so that the section 222 does not come into contact with the screen/glass frame 27. Section 224 has inner walls 242-246 that contact the support post 24, side walls 248, 250 that are parallel to screen/glass 25, notches 252, 254 and outer wall 256. The side walls 248, 250 may contact the screen/glass 25 or be separated from the screen/glass 25 by a gap. The notches 252, 254 are sized so that the section 224 does not come into contact with the screen/glass frame 27.

The post planters can be attached to the support posts by a variety of methods. As previously indicated, the tops may be held together by clips, including the interlock mechanism 54. Those skilled in the art will recognize that the tops may be held together by other means such as glue or bonding for post planters that are permanently mounted, a tongue and groove mechanism, a VELCRO hook and loop type fastener, etc.

In one embodiment, the post planters are mounted to the support post by nails or screws. In the post planters having holes, one or more mounting holes are placed on the inner surface. The mounting holes are aligned with holes 30 so that a screw driver can be used to mount the post planter via screws. Alternatively the post planter may be nailed into place.

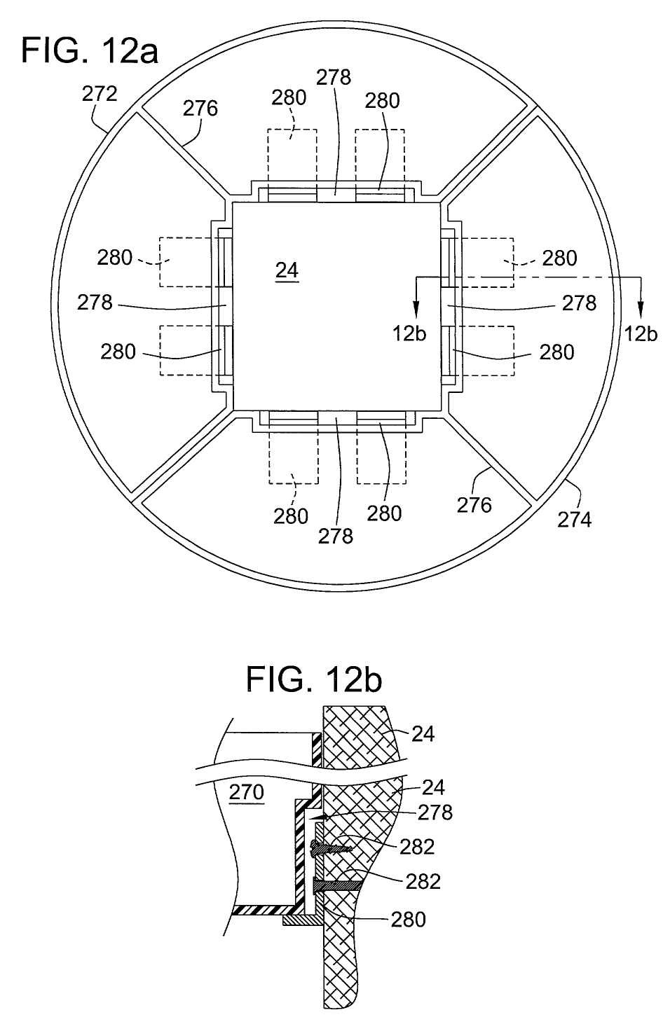

In an alternate embodiment, the post planters are mounted using angle brackets. Turning now to FIG. 12a, the post planter 270 is comprised of two sections 272, 274. Each section 272, 274 has a divider 276 that allows plants within the sections 272, 274 to be isolated from each other. In one embodiment, the divider 276 is removable. Each section 272, 274 also has at least one recess 278 of sufficient length and width to allow one or more angle brackets 280 to fit within the recess 278. The angle brackets 280 are mounted to the support post 24 (with screws/nails 282) and each section 272, 274 are fit on their respective angle brackets so that the bottom of the sections 272, 274 sit on the angle brackets 280. The angle brackets 280 are sized to hold the weight of the section, dirt fill, and plant. While FIG. 12a shows a continuous recess along the inner walls, it should be recognized that the recess may be hidden from the top of the post planter 270 so that it is not seen (see FIG. 12b).

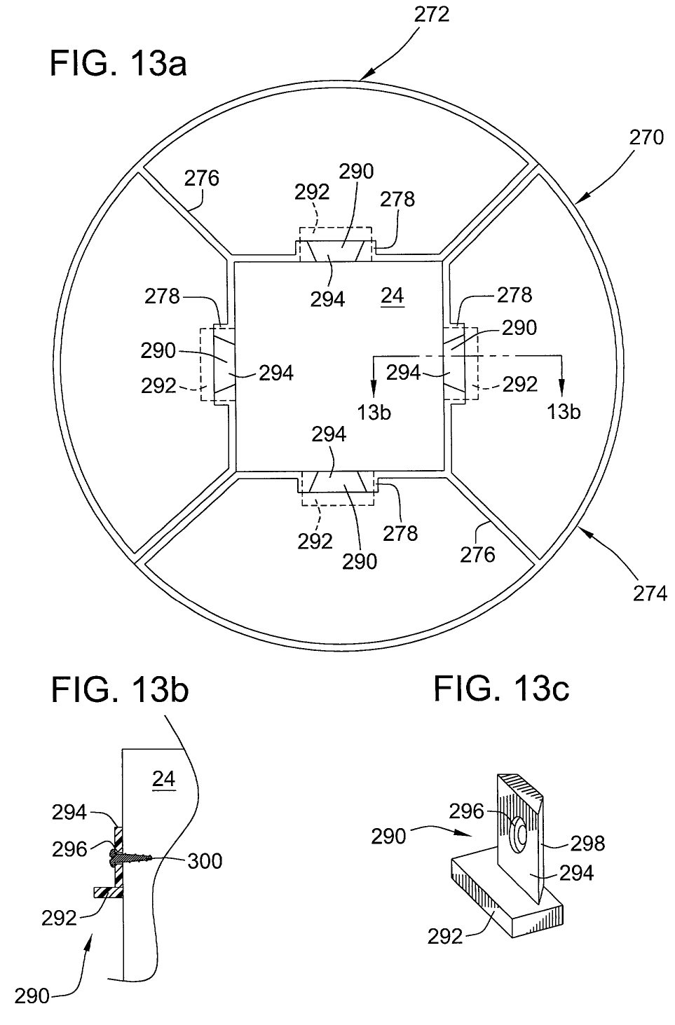

Another alternate embodiment of a mounting mechanism is shown in FIGS. 13a13c. The mounting mechanism 290 comprises base 292 and vertical section 294. The vertical section 294 has mounting hole 296 for mounting the mounting mechanism to the support post 24 via screws/nails 300. The vertical section 294 may be any shape (rectangular, square, etc.). In the embodiment shown the vertical section 294 is trapezoidal in shape. While the recess wall 279 is illustrated as being substantially orthogonal to the support post surface in which the mounting mechanism is mounted, the recess wall 279 can be manufactured to be at an angle to the support post surface such that the recess wall 279 is substantially parallel to the wall 298 of the vertical section 294. This allows the post planter 270 to be guided into place by the wall 298 and held from moving outward by the recess wall 279 contacting the wall 298 if the length of the recess 278 is sized properly. While FIG. 13a shows a continuous recess along the inner walls, it should be recognized that the recess may be hidden from the top of the post planter 270 so that it is not seen.

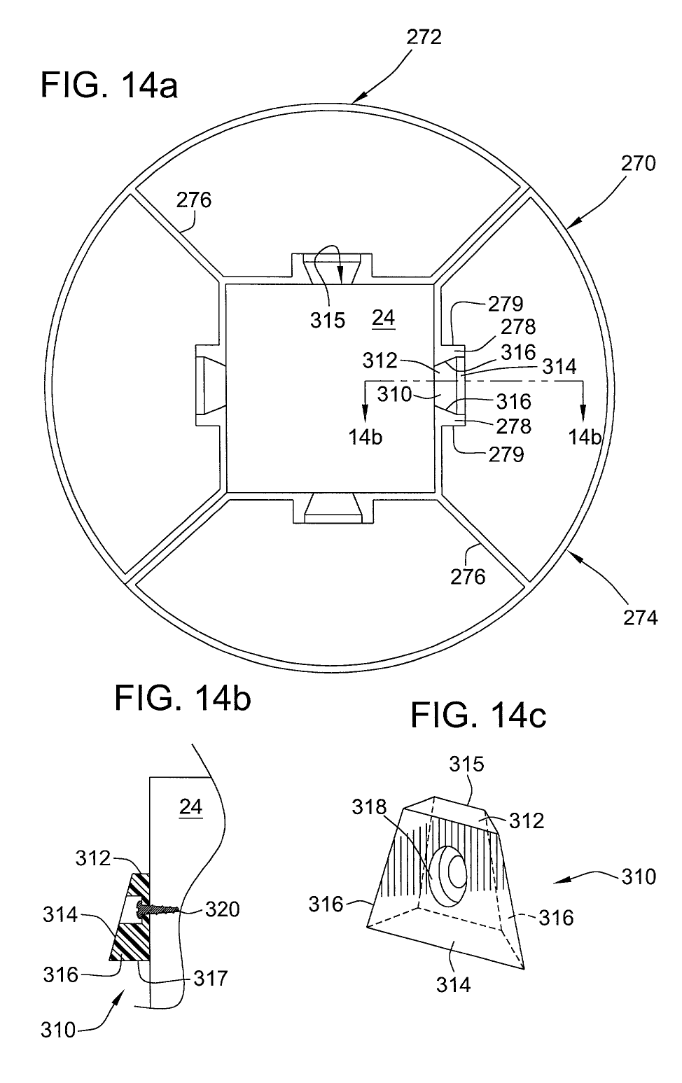

Turning now to FIGS. 14a-14c, an alternative embodiment of a mounting mechanism is shown. The mounting mechanism 310 has a top 312, front face 314, rear face 315, sides 316, and bottom 317. The mounting mechanism 310 has mounting hole 318 for mounting the mounting mechanism 310 to the support post 24 via screws/nails 320. The mounting hole 318 may be countersunk so that the screw/nail 320 is flush with the front face 314. The top 312 and bottom 317 may be any shape (rectangular, square, etc.) and is shown as being trapezoidal in shape. In one embodiment, the face 304 is angled outwardly from the rear face 315 so that it presses against the recess wall 322 and holds the post planter 270 in place (see FIGS. 14b and 14c). The sides 316 may also extend downwardly outwardly.

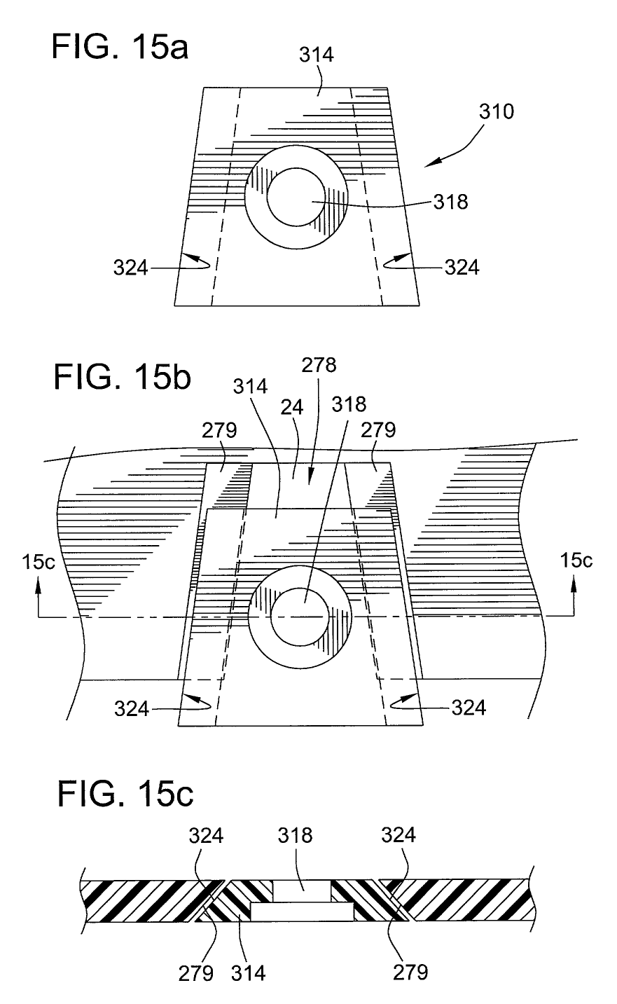

In an alternative embodiment, the edges 324 of the front face 314 extend downwardly outwardly (see FIG. 15a). The recess 278 is sized such that the recess wall 279 contacts the edges 324 and holds the post planter 270 in place. The recess wall 279 may be angled so that the recess walls 279 are parallel to the edges 324 (see FIGS. 15b and 15c). This allows the mounting mechanism to act as a wedge to hold the post planter 270 in place.

The post planter may be manufactured using a variety of materials and methods known to those persons skilled in the art. The post planter can be made of a durable plastic material using injection molding, thermoforming, etc. The post planter can also be ceramic, clay, terra cotta, metal, glass, fiberglass, Styrofoam, etc. The mounting mechanism may also be manufactured by the same material and methods.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A planter for mounting around a post comprising:
a first planter section having a first outer wall, a plurality of first side walls, at least one first inner wall, and a first bottom wall, the first outer wall having a plurality of holes and the first bottom wall having a drainage hole;
a second planter section having a second outer wall, a plurality of second side walls, at least one second inner wall, and a second bottom wall, the second outer wall having a plurality of holes and the second bottom wall having a drainage hole; and
means for holding the first planter section and the second planter section to the post.

2. The planter of claim 1 wherein the first planter section and the second planter section are held together by a clip.

3. The planter of claim 1 wherein at least one of the plurality of first side walls and the plurality of second side walls has a slot located at a top of the at least one of the plurality of first side walls and the plurality of second side walls and wherein the planter includes an interlock mechanism located on the other of the at least one of the plurality of first side walls and the plurality of second side walls, whereby the interlock mechanism comprises:
a first section approximately orthogonal to the other of the at least one of the plurality of first side walls and the plurality of second side walls that moves over the slot; and
a second section approximately orthogonal to the first section such that the second section holds the at least one of the plurality of first side walls and the plurality of second side walls to the other of the at least one of the plurality of first side walls and the plurality of second side walls.

4. The planter of claim 1 further comprising at least one lip located proximate to one of the holes.

5. The planter of claim 1 wherein the first bottom wall and the second bottom wall are curved.

6. The planter of claim 1 wherein the first planter section and the second planter section are identical.

7. The planter of claim 1 wherein the means for holding the first planter section and the second planter section to the post comprise at least one of screws and nails.

8. The planter of claim 1 wherein one of the plurality of first side walls and the plurality of second side walls has a groove and the other of the plurality of first side walls and the plurality of second side walls has a tongue whereby the first planter section and the second planter section are held together by the tongue and groove.

9. The planter of claim 1 further comprising a mounting recess located on at least one of the at least one first inner wall and the at least one second inner wall for receiving a mounting mechanism.

10. The planter of claim 9 wherein the means for holding the first planter section and the second planter section to the post comprises a mounting mechanism, the planter being attached to the post by sliding the first planter section and the second planter section onto the mounting mechanism.

11. The planter of claim 1 wherein the first planter section and the second planter section are plastic.

12. The planter of claim 1 wherein the first planter section and the second planter section are ceramic.

13. A planter for mounting around a post comprising:
a first planter section having a first outer wall, a plurality of first side walls, at least one first inner wall, and a first bottom wall, the first outer wall having a plurality of holes and the first bottom wall having a drainage hole;
a second planter section having a second outer wall, a plurality of second side walls, at least one second inner wall, and a second bottom wall, the second outer wall having a plurality of holes and the second bottom wall having a drainage hole;
at least one lip attached to one of the plurality of holes; and
a clip connected to the first planter section and the second planter section for holding the first planter section to the second planter section.

13. The planter of claim 11 wherein the at least one first inner wall and the at least one second inner wall have a mounting recess whereby the first planter section and the second planter section are held to the post by placing the first planter section and the second planter section around the post such that a mounting mechanism attached to the post fits within the recess, thereby holding the first planter section and the second planter section to the post.

14. The planter of claim 11 wherein the first planter section and the second planter section are plastic.

15. The planter of claim 11 wherein the first planter section and the second planter section are ceramic.

16. The planter of claim 11 wherein the at least one first inner wall and the at least one second inner wall have a mounting recess, wherein the planter includes a mounting mechanism that fits within the mounting recess.

17. The planter of claim 16 wherein the mounting mechanism comprises:
a vertical section having a mounting hole; and
a base connected to the vertical section, the base having an area sufficient to hold the planter in place.

18. The planter of claim 16 wherein the mounting mechanism comprises a wedge shaped device that wedges the planter in place.
